(19) United States
(12) Patent Application Publication
(10) Pub. No.: US 2011/0249035 A1
(43) Pub. Date: Oct. 13, 2011

(54) LIQUID CRYSTAL DISPLAY DEVICE AND TELEVISION RECEIVER

(75) Inventor: Masahiro Arai, Osaka (JP)

(73) Assignee: Sharp Kabushiki Kaisha, Osaka-shi, Osaka (JP)

(21) Appl. No.: 12/998,923

(22) PCT Filed: Oct. 5, 2009
(86) PCT No.: PCT/JP2009/067327

§ 371 Date: Jun. 16, 2011

(30) Foreign Application Priority Data
Dec. 26, 2008 (JP) 2008-333349

(51) Int. Cl. G09G 3/36; G09G 5/10

(52) U.S. Cl. 345/690; 345/102

(57) ABSTRACT

A liquid crystal display device includes an image signal processing section configured to control a liquid crystal panel and a backlight unit in a liquid crystal display device based on an image signal and detect that an image displayed on the liquid crystal panel is changed to a whole-area black display image based on the image signal. The liquid crystal display device further includes a backlight unit control section that generates a dimming signal Sdv in response to detection by the image signal processing section and supplies the dimming signal sdv to the backlight unit. The dimming signal Sdv lowers luminescence brightness Lca of the backlight unit to be substantially zero in a gradual manner.

### TECHNICAL FIELD

The present invention relates to a liquid crystal display device and a television receiver including the liquid crystal display device, and more particularly relates to power saving of a backlight unit of the liquid crystal display device.

### BACKGROUND ART

A backlight unit using discharge tubes such as CCFL (cold cathode fluorescent tubes) has been known as a backlight unit of a liquid crystal display device of a liquid crystal television. A backlight unit using a plurality of LED (Light Emitting Diode) elements has been recently used. Generally, power consumption of the liquid crystal display device is greater in the backlight unit than in the liquid crystal panel. Therefore, it is required to reduce the power consumption of the backlight unit to suppress increase of the power consumption due to increase in size of the liquid crystal display device.

For example, Patent Document 1 discloses a technology of reducing power consumption of the backlight unit as described below. If the backlight unit has no image signal that is to be displayed on a liquid crystal panel in a standby mode, an auxiliary image is displayed on the liquid crystal panel and the LED elements corresponding to the black display parts of the auxiliary image are turned off.
[Patent Document 1] Japanese Unexamined Patent Publication No. 2007-86390

### PROBLEM TO BE SOLVED BY THE INVENTION

In the above-described technology, power saving is achieved with providing good impressions to audience when there is no image signal such as a TV image signal (in a standby mode). However, even if there is an image signal, power saving of the backlight unit may be achieved in a whole area of the liquid crystal panel depending on a display image. Therefore, it is desired to achieve power saving of the backlight unit in a whole area of the liquid crystal panel with a simple method.

### DISCLOSURE OF THE PRESENT INVENTION

The present invention was made in view of the foregoing circumstances. An object of the present invention is to provide a liquid crystal display device and a television receiver having the liquid crystal display device that easily achieves power saving of a backlight unit in a whole area of a liquid crystal panel.

### MEANS FOR SOLVING THE PROBLEM

To solve the above problem, a liquid crystal display device of the present invention includes a liquid crystal panel configured to display images, a backlight unit configured to illuminate a rear surface of the liquid crystal panel, and a backlight unit control section configured to control luminescence brightness of the backlight unit. The liquid crystal display device further includes an image signal processing section configured to control the liquid crystal panel and the backlight unit based on an image signal and detect that the image on the liquid crystal panel is a black display image. In the liquid crystal display device, the backlight unit control section generates a dimming signal that lowers the luminescence brightness to be substantially zero in a gradual manner in response to detection of the black display image and supplies the dimming signal to the backlight unit.

With such a configuration, when the black display image is displayed on the liquid crystal panel, the luminescence brightness of the backlight unit is lowered to be substantially zero in a gradual manner. Therefore, power saving of the backlight unit in a whole area of the liquid crystal panel is easily achieved only by the detection that the image on the liquid crystal panel is the black display image. In such a case, the luminescence brightness is lowered in a gradual manner, and therefore, uncomfortable feeling is less likely to be brought to audience when the backlight unit is turned off. In the above description, the word of “substantially zero” includes zero.

### BRIEF DESCRIPTION OF THE DRAWINGS

FIG. 1 is a block diagram illustrating a general electrical configuration of a television receiver according to an embodiment of the present invention;

FIG. 2 is a plan view illustrating a general construction of a backlight unit of the liquid crystal display device;

FIG. 3 is a cross-sectional view illustrating a general construction of a liquid crystal display device;

FIG. 4 is a timing chart generally illustrating time-shift of each signal relating to power saving control of a backlight unit;

FIG. 5 is a plan view generally illustrating another construction of the backlight unit; and

FIG. 6 is a cross-sectional view generally illustrating another construction of the liquid crystal display device.

### BEST MODE FOR CARRYING OUT THE INVENTION

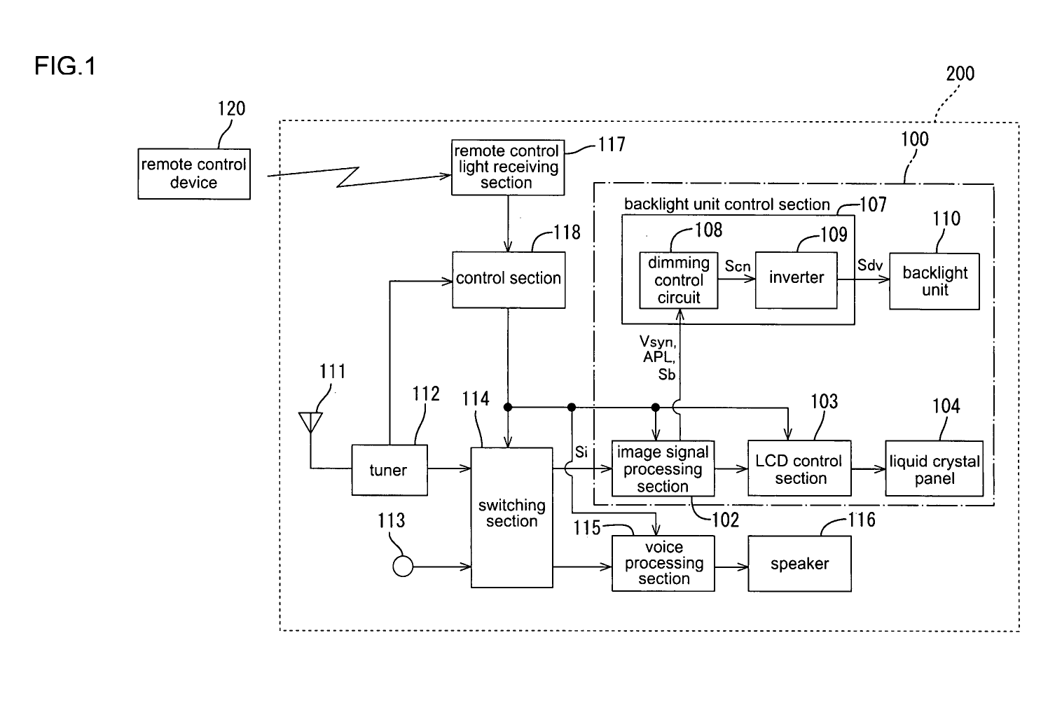

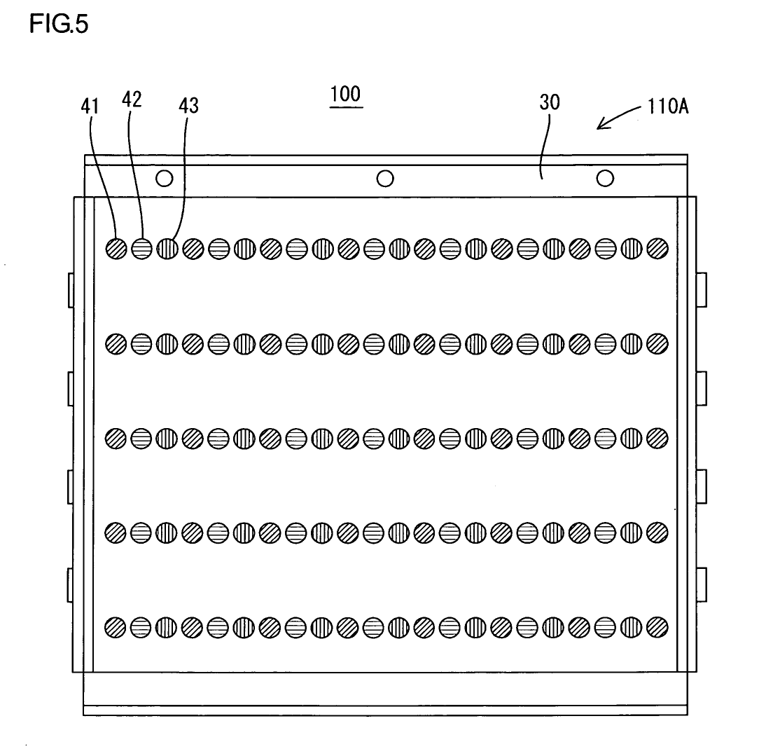

One embodiment of the present invention will be explained with reference to FIGS. 1 to 5. In the present embodiment, a television receiver including a liquid crystal display device of the present invention will be explained. The liquid crystal display device of the present invention is not limited thereto but may be applied to any devices capable of displaying images such as a personal computer, a game machine, a measuring device and the like.

1. Structure of Television Receiver

FIG. 1 is a general block diagram illustrating a construction of a television receiver 200 including a liquid crystal display device 100 of the present invention. In the television receiver 200, an antenna 11 receives television broadcasting signals and a tuner 112 tunes in one of the received signals. A video input terminal 113 receives video signals from an AV device that is built in the television receiver 200 or externally connected to the television receiver 200. A switching section 114 switches between the television broadcasting signal selected by the tuner 112 and the video signal input via the video input terminal 113 and outputs the switched signal. The image signal Si output from the switching section 114 is processed by an image signal processing section 102 of the liquid crystal display device 100.

In the television receiver 200, voice signals output from the switching section 114 are processed by a voice processing section 115 and voice is output from a speaker 116. A remote control light receiving section 117 receives infrared rays representing remote control operation signals that are transmitted from a remote control device 120 and transmits the received signals to a control section 118. The control section 118 detects and analyzes the remote control operation signals received by the remote control light receiving section 117 and outputs control signals to the tuner 112, the switching section 114, the image signal processing section 102, an LCD control section 103 and the voice processing section 115 to control the operations thereof.

2. Construction of Liquid Crystal Display Device

Next, the liquid crystal display device 100 will be explained. As illustrated in FIG. 1, the liquid crystal display device 100 includes the image signal processing section 102, the LCD (liquid crystal display device) control section 103, the liquid crystal panel 104, a backlight unit control section 107 and the backlight unit 110.

The image signal processing section 102 processes an image signal Si input to the liquid crystal display device 100 or an image signal Si that is read from a recording medium of a read/write device (not illustrated) that is built in the liquid crystal display device 100. The image signal processing section 102 performs various image quality improvement processing to the image signal Si if necessary and generates image display signals such as RGB signals appropriate for activating the liquid crystal panel 104. The generated image display signals are transmitted to the LCD control section 103.

The image signal processing section 102 generates backlight unit control signals such as vertical synchronizing signals Vsyn that are to be transmitted to the backlight unit control section 107 to control light emission of the backlight unit 110. The image signal processing section 102 computes an average picture level (APL) based on the image signals Si and generates an APL signal according to the APL as the backlight unit control signal. For example, if the APL is equal to or less than a black display determination value, the image signal processing section 102 detects that an image that is to be displayed on the liquid crystal panel 104 is a black display image and generates a black display detection signal Sb. The APL signal and the black display detection signal Sb are transmitted to the backlight unit control section 107.

The LCD control section 103 generates LCD data that is light transmission data of each pixel of the liquid crystal panel 104 according to the image display signal transmitted from the image signal processing section 102. The LCD control section 103 generates an LCD drive signal according to the LCD data and transmits the LCD drive signal to the liquid crystal panel 104 to control image display on the liquid crystal panel 104.

The liquid crystal panel 104 is formed in a rectangular shape with a plan view and constructed such that a pair of glass substrates is bonded together with a predetermined gap therebetween and liquid crystal is sealed between the glass substrates.

On one of the glass substrates, switching components (e.g., TFTs (thin film transistors)) connected to source lines and gate lines that are perpendicular to each other, pixel electrodes connected to the switching components, and an alignment film are provided. On the other substrate, a color filter having color sections such as R (red), G (green) and B (blue) color sections arranged in a predetermined pattern, common electrodes, and an alignment film are provided.

With such a construction, for example, color pixels of 1920*1080 dots for high vision are formed in the liquid crystal panel 104. Further, an LCD driver is provided in the liquid crystal panel 104. The LCD driver controls the switching element of each pixel according to the LCD drive signal transmitted from the LCD control section 103 and the image is displayed on the liquid crystal panel 104 according to the image signals Si.

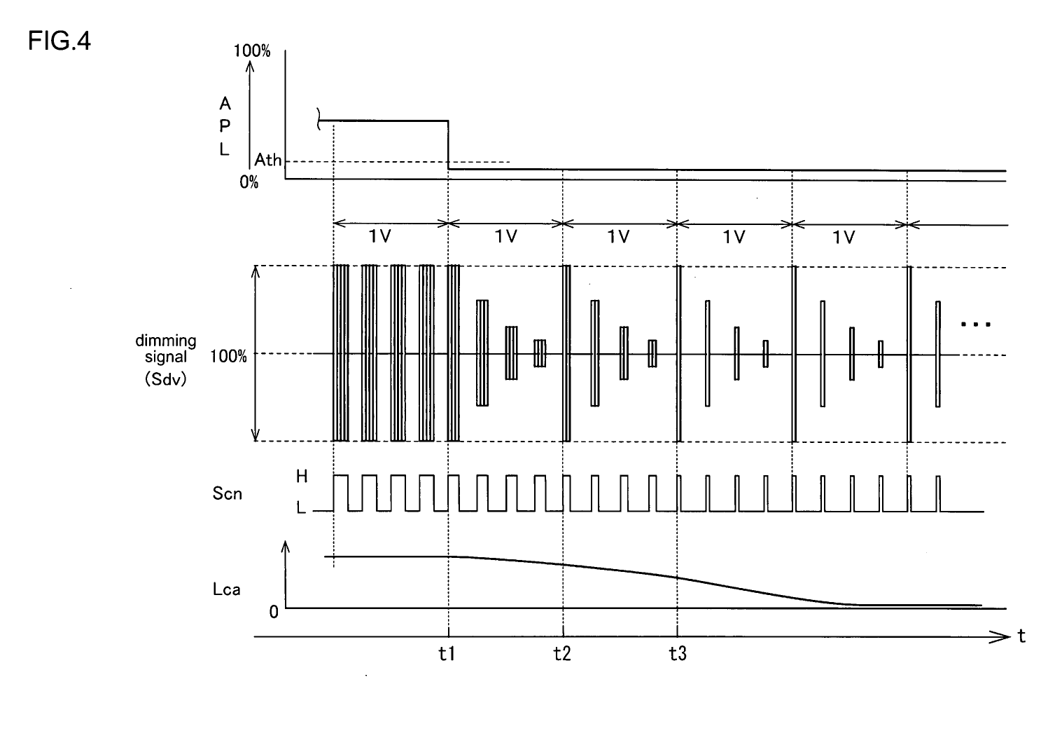

The backlight unit control section 107 includes the dimming control circuit 108 and the inverter 109. In response to the detection of a black display image by the image signal processing section 102, the backlight unit control section 107 generates a dimming signal Sdv that lowers luminescence brightness Lca of the backlight unit 110 to be substantially zero in a gradual manner and supplies the dimming signal Sdv to the backlight unit 110 (see FIG. 4). A value of the luminescence brightness Lca that is substantially zero is, for example, 0.01 cd/m2 or less (including zero).

The dimming control circuit 108 generates a control signal Scn that is a pulse width modulation (PWM) signal. The PWM signal changes a signal duration ratio (duty cycle) of a high potential level and a low potential level of a rectangular wave according to the APL signal transmitted from the image signal processing section 102.

The inverter 109 has a known configuration. The inverter 109 generates a dimming signal Sdv that is burst AC voltage according to the control signal Scn. The burst dimming signal Sdv is supplied to the backlight unit 110 as a drive signal for driving a fluorescent tube. The inverter 109 executes a switching operation when the control signal Scn is at a high potential level and stops the switching operation when the control signal Scn is at a low potential level. Thus, the inverter 109 executes an intermittent action according to the duty cycle of the control signal Scn and generates a burst dimming signal Sdv (see FIG. 4). Brightness of the backlight unit 110 is controlled by the duty cycle and amplitude of the burst dimming signal Sdv.

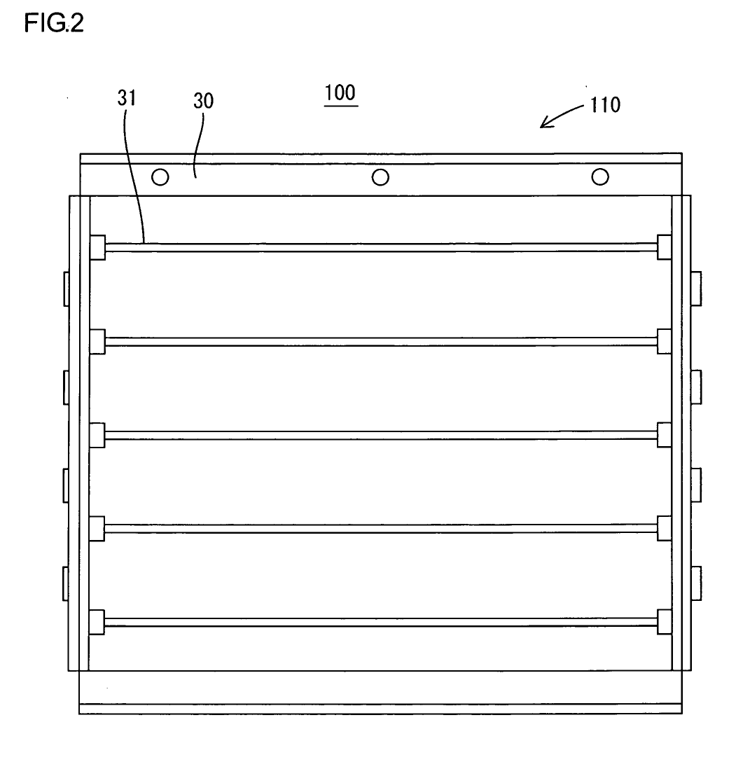

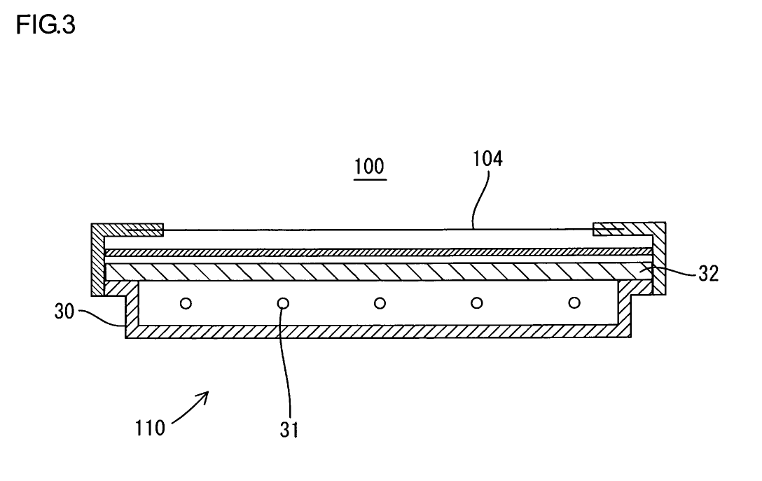

The backlight unit 110 irradiates a rear surface of the liquid crystal panel 104 with light and the liquid crystal panel 104 controls an amount of light that is irradiated and transmits through the liquid crystal panel 104 to form an image thereon. As illustrated in FIGS. 2 and 3, the backlight unit 110 of the present embodiment includes a frame 30 that is attached to the rear surface of the liquid crystal panel 104. In the frame 30, a number of fluorescent tubes of narrow tubes such as CCFL (cold cathode fluorescent tubes) 31 are arranged parallel to each other at equal intervals. Each fluorescent tube 31 is driven to be lit on by the burst dimming signal Sdv. A diffuser plate 32 evenly diffuses illumination light emitted from each fluorescent tube 31.

3. Power Saving Control of Backlight Unit

With reference to FIG. 4, power saving control of the backlight unit will be explained. FIG. 4 is a timing chart generally illustrating time-shift of each signal relating to power saving control of the backlight unit.

If the image displayed on the liquid crystal panel 104 at time t1 in FIG. 4 is changed to the black display, the APL value computed by the image signal processing section 102 is lowered to approximately 0% and it is lower than the black display determination value Ath (for example, 3%). Accordingly, the image signal processing section 103 detects a black display of the displayed image and generates the black display detection signal Sb. The black display detection signal Sb is transmitted to the dimming control circuit 108. The black display determination value Ath is appropriately set as the APL value for determining a black display. For example, the black display determination value Ath is set to be 3% or less. The black display determination value Ath may be changed according to a type of the image that is to be displayed on the liquid crystal panel 104.

When receiving the black display detection signal Sb, the dimming control circuit 108 reduces the duty cycle of the control signal Scn in one frame period (1V) starting from time t1 in FIG. 4 compared to the duty cycle of the control signal Scn before the time t1 in FIG. 4. For example, the duty cycle is reduced from 50% to 35%. Accordingly, the inverter 109 generates the dimming signal Sdv that lowers the luminescence brightness Lca of the backlight unit 110 to be substantially zero in a gradual manner. Timing control in one frame period (1V) is executed by a vertical synchronizing signal Vsyn transmitted from the image signal processing section 103. Namely, the one frame period (1V) is equal to a pulse interval of the vertical synchronizing signal.

Power source voltage supplied to the inverter 109 is reduced in a gradual manner to reduce amplitude of the dimming signal Sdv in a gradual manner during a period from the time t1 to time t2 in FIG. 4. Accordingly, the amplitude of the signal supplied to a primary side of a transformer of the inverter 109 is gradually reduced and the dimming signal Sdv that gradually reduces the amplitude in the one frame period (1V) is generated at a secondary side of the transformer, as illustrated in FIG. 4. A method of reducing the amplitude of the dimming signal Sdv in the one frame period (1V) is not limited thereto.

The dimming control circuit 108 reduces the duty cycle of the control signal Scn in the one frame period (1V) starting from the time t2 in FIG. 4 from 35% to 15%, for example. Then, the dimming control circuit 108 reduces the duty cycle of the control signal Scn in the one frame period (1V) starting from time t3 in FIG. 4 from 15% to 7.5% that is a final value of the duty cycle.

As illustrated in FIG. 4, the amplitude of the dimming signal Sdv is reduced gradually in each frame period (1V). In each frame period (1V) after the time t3 in FIG. 4, the duty cycle is same and is the final value. The final value of the duty cycle is previously determined by an experiment as a predetermined duty ratio that does not completely stop discharge from the fluorescent tube 31. The discharge from the fluorescent tube 31 is not completely stopped because it takes time to start discharging from the fluorescent tube 31 again after the discharge from the fluorescent tube 31 is stopped. Therefore, the discharge from the fluorescent tube 31 is not completely stopped so that the luminescence brightness Lca is changed in a smooth manner when the display on the liquid crystal panel 104 is changed from the black display.

As is explained above, in the present embodiment, in response to the detection of the black display image by the image signal processing section 102, the dimming control circuit 108 of the backlight unit control section 107 gradually reduces the duty cycle of the dimming signal Sdv that is a burst signal by every frame period unit. The dimming control circuit 108 reduces the amplitude of the dimming signal Sdv in a gradual manner in each frame period.

Therefore, when the display image on the liquid crystal panel 104 is changed to the black display, the luminescence brightness of the backlight unit 110 is lowered in a gradual manner to be substantially zero, as illustrated in FIG. 4. This achieves power saving of the backlight unit 110 in a whole area of the liquid crystal panel 104. The luminescence brightness Lca is lowered in a gradual manner, and uncomfortable feeling is less likely to be brought to audience when the backlight unit 110 is turned off.

### Other Embodiments

The embodiments of the present invention have been described, however, the present invention is not limited to the above embodiments explained in the above description and the drawings. The following embodiments may be included in the technical scope of the present invention, for example.

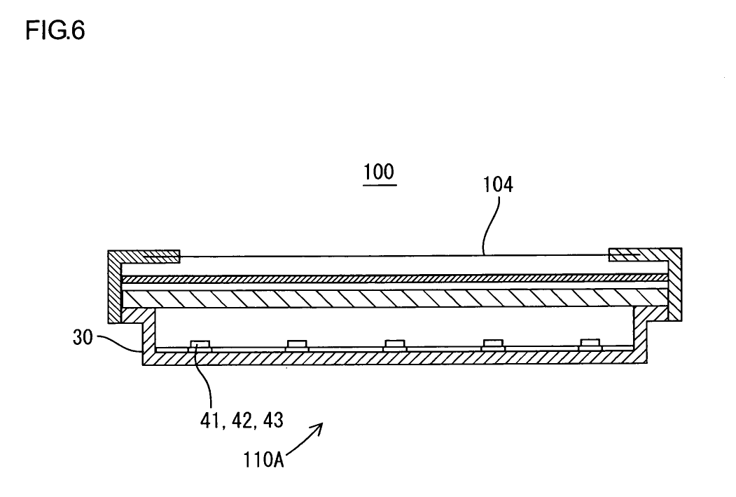

(1) In the above embodiment, the backlight unit 110 includes the fluorescent tubes 31. However, as illustrated in FIGS. 6 and 7, a backlight unit 110A may include a number of light emitting diodes (LED) of RGB in the frame body 30 that is to be attached to the rear surface of the liquid crystal panel 20. The light emitting diodes of RGB include red LEDs 41, green LEDs 42 and blue LEDs 43.

In such a case, in response to the detection of the black display image by the image signal processing section 102, the backlight unit control section 107 generates the dimming signal Sdv according to the APL signal from the image signal processing section 102 and controls the dimming signal Sdv to lower the luminescence brightness of each LED (41, 42, 43) in a gradual manner. A dimming method of the LED may include a voltage (current) control dimming method or a duty cycle control dimming method that is a brightness time-sharing method. In response to the detection of the black display image, the number of the LEDs that emit light may be reduced to a predetermined number (including zero) in a gradual manner.

In the voltage (current) control dimming method, the backlight unit control section 107 changes input voltage or input current from a power source circuit (not illustrated) with a DC-DC converter and reduces the drive voltage (current) by every frame unit. In the duty cycle control dimming method, the backlight unit control section 107 generates a dimming pulse (PWM signal) that drives the LEDs and reduces a pulse width (duty cycle) of the PWM signal by every frame unit.

In the backlight unit 110A including the light emitting diodes, the luminescence brightness may be lowered to be zero in a gradual manner to achieve the black display. Because light emission rise time of the light emitting diode is shorter than the fluorescent tube, uncomfortable feeling is not likely to be brought to audience when the light emitting diode is lit on again. In such a case, the light emitting diode is turned off completely, and this reduces power consumption of the backlight unit to be a lowest value.

(2) In the above embodiments, the black display on the liquid crystal panel 104 is detected based on the APL (average picture level). However, for example, the black display on the liquid crystal panel 104 may be detected based on a black level signal included in the image signal Si or based on the APL and the black level signal. The black display on the liquid crystal panel 104 may be detected based on the APL and a maximum brightness level. The black display can be detected by detecting black display on the liquid crystal panel 104 based on the image signal Si.

(3) In the above embodiments, the luminescence brightness of the backlight unit (110, 110A) is lowered in a gradual manner by every frame unit (a predetermined time period unit). However, the luminescence brightness of the backlight unit may be lowered by every unit including two frames or every unit including three frames, or may not be reduced by the frame unit. Further, the luminescence brightness may not be lowered by a predetermined time period unit such as the frame unit. Any method may be applied as long as the dimming signal Sdv is generated so that the luminescence brightness Lca of the backlight unit (110, 110A) is lowered to be substantially zero in a gradual manner.

(4) In the above embodiment, as illustrated in FIG. 4, the amplitude of the dimming signal Sdv is reduced in every frame period to lower the luminescence brightness of the backlight unit (110, 110A). However, the amplitude of the dimming signal may be constant and only the duty cycle may be reduced. Further, the amplitude of the dimming signal Sdv is not reduced in every frame period and the amplitude may be reduced in every frame period unit or the amplitude may be reduced without having relation to the frame unit.

1. A liquid crystal display device comprising:
a liquid crystal panel configured to display images;
a backlight unit configured to illuminate a rear surface of the liquid crystal panel;
a backlight unit control section configured to control luminescence brightness of the backlight unit; and
an image signal processing section configured to control the liquid crystal panel and the backlight unit based on an image signal and detect that the image on the liquid crystal panel is a black display image, wherein
the backlight unit control section generates a dimming signal that lowers the luminescence brightness to be substantially zero in a gradual manner in response to detection of the black display image and supplies the dimming signal to the backlight unit.

2. The liquid crystal display device according to claim 1, wherein the backlight unit control section generates the dimming signal by a unit of a predetermined time period.

3. The liquid crystal display device according to claim 2, wherein the predetermined time period is one frame period.

4. The liquid crystal display device according to claim 1, wherein:
the backlight unit includes a fluorescent tube as a light source;
the dimming signal is a burst signal that alternately switches lighting of the fluorescent tube between on and off; and
the backlight unit control section reduces amplitude and/or a duty cycle of the burst signal in a gradual manner in response to the detection of the black display image.

5. The liquid crystal display device according to claim 1, wherein:
the backlight unit includes a light emitting diode as a light source; and
the backlight unit control section lowers luminescence brightness of the light emitting diode in a gradual manner in response to the detection of the black display image.

6. The liquid crystal display device according to claim 5, wherein the backlight unit control section lowers the luminescence brightness of the light emitting diode to be zero.

7. A television receiver comprising the liquid crystal display device of claim 1.
